(19) United States
(12) Patent Application Publication
(10) Pub. No.: US 2002/0147508 A1
(43) Pub. Date: Oct. 10, 2002

(54) Setting and using policy goals in process control

(76) Inventors: Christopher A. Miller, St. Paul, MN (US); John A. Allen, New Brighton, MN (US); Rahima Kaba, Toronto (CA); Michael C. Dorneich, St. Paul, MN (US); Stephen D. Whitlow, Rogers, MN (US); James P. Richardson, St. Paul, MN (US); Harry B. Funk, Minneapolis, MN (US)

Correspondence Address: CROMPTON, SEAGER & TUFTE, LLC, Suite 895, 331 Second Avenue South, Minneapolis, MN, 55401-2246, US

(21) Appl. No.: 10/099,746

(22) Filed: Mar. 13, 2002

Related U.S. Application Data
(60) Provisional application No. 60/276,379, filed on Mar. 16, 2001.

(51) Int. Cl. G05B 13/02

(52) U.S. Cl. 700/30

(57) ABSTRACT

Methods and apparatus for setting policy goals and using the policy goals to assist in controlling a process or system are disclosed. The policy goals preferably codify some or all of an organization's policy goals for the operation of the process or system. The policy goals preferably express what an organization considers a good (or bad) solution and what level of goodness (or badness) the situation or solution incurs given a particular context. The operation of the process or system can then be evaluated using the predefined policy goals.

This application claims priority under 35 U.S.C. §119(e)(1) to U.S. Provisional Patent Application Serial No. 60/276,379, filed Mar. 16, 2001, and entitled “POLICY METRICS FOR VISUALIZATION, LEARING AND DECISION GUIDANCE”.

### FIELD OF THE INVENTION

The present invention relates generally to process control, and more particularly, to methods and apparatus for using policy goals to optimize process operation and performance.

### BACKGROUND OF THE INVENTION

There are a vast number of systems in use today for controlling various processes such as manufacturing processes, business processes, scheduling processes, etc. In many cases, what is defined as an “optimum” or “good” solution for process control depends on the policy goals of the process. For example, in a manufacturing process, a policy goal may be to produce tight tolerances, or alternatively, to minimize material use. If the execution of the process produces tight tolerance but does not minimize material used, the process may be viewed as “optimum” or “good” when using one policy goal, and relatively “bad” when using the other policy goal. As can be seen, what is viewed as an “optimum” or “good” solution for process control can depend on the policy goals that are expected of the process.

An airline flight operation is another example process where the “goodness” of a solution can depend on one or more policy goals. Flight operation planning often begins with the creation of a plan that includes aircraft routes and schedules, crew assignments, gate assignments, etc. During plan execution, the flight schedule can be frequently disrupted due to factors such as weather, mechanical failures, and/or other unforeseen circumstances. Predicting the impact of such disruptions can be complex due to the interdependent nature of resources and schedules. Determining an appropriate solution to the disruptions can be equally challenging.

In one example, if a flight is unable to land at its original destination, dispatchers must typically decide where to divert the flight. These diversion decisions can have a dramatic impact on other parts of the planned schedule. For example, a flight diversion can affect connecting flight schedules, crew schedules and assignments, aircraft maintenance schedules, passenger schedules, etc.

Determining whether a diversion decision is an “optimum” or “good” decision often depends on the policy goals of the airline at that time. For example, an airline may not want to divert flights on routes that have been heavily promoted as reliable. Likewise, an airline may not want to overload one airport with too many diverted flights, particularly of there are not enough gates available to accommodate the flights. In another example, an airline may not want to divert flights that have passengers with connecting flights, etc. All of these policy goals may be time dependent.

Typically, there are multiple possibilities for a diversion while still maintaining safe flight and landing criteria, each differing widely in its impact on various aspects of airline operations, profits, and customer convenience and satisfaction. Currently, flight diversion decisions are often made with limited information, often because the information is spread across different systems and different departments. In addition, due to priorities and time pressures, dispatchers are often not able to thoroughly analyze the interactions between different solutions to determine the impact of their decision on airline operations. In addition, and in many cases, dispatchers do not have access to recent or timely policy goals of the airline. What is needed, therefore, is a method and apparatus for setting policy goals for a process, and using the policy goals to assist in controlling the process.

### SUMMARY OF THE INVENTION

The present invention provides a method and apparatus for setting policy goals, and using the policy goals to assist in controlling a process. In one illustrative embodiment, the present invention is used to help control airline flight operations. In this context, a policy may be a statement of desirable and/or undesirable world states, i.e., goals, with or without an associated measure of priority. Alternately, or in addition, the policy may be a rule that may have an associated priority represented as a penalty, absolute or relative to other priorities, should the policy be violated. These policy statements may codify some or all of an organization's policy goals for the process. The policy goals preferably express what an organization considers a good (or bad) solution and what level of goodness (or badness) the situation or solution incurs given a particular context. The policy goals may be defined a priori, and applied when a decision must be made regarding the process.

In applying the notion of policy goals to the domain of integrated flight operations, for example, various levels of Air Operations Center (AOC) dispatcher policies may be represented as a set of policy goals. In the AOC domain, multiple information sources may be integrated for improving a dispatcher's awareness to situations such as state of flight, maintenance, crew, and passenger schedules. This broader awareness of the various constraints can help formulate an optimum or “good” flight operational decision, because more information is available and because the policy goals can operate on a wider range of information.

In one illustrative embodiment, various types of policy goals are provided including, for example, physical laws, Federal Aviation Administration (FAA) regulations, safety constraints, standard operating procedures, and operator or organization preferences. If one or more of the policy goals is violated by a proposed solution, penalty values are assessed to indicate the severity of the violation relative to other violations. For example, a policy goal stating “Do not delay flights with 1^{st}class passengers who have international connections” may have 8 penalty points (on a scale from 1 to 10; 1 being the least severe and 10 being the most severe). If a proposed diversion delays a flight with 1^{st} class passengers who have international connections, 8 penalty points may be assigned to that solution. A solution with a low number of aggregate penalty points is preferably selected for execution.

Provisions for a user to specify policy goals using easily readable functional relationships may also be provided. This may allow personnel, including those that do not have detailed knowledge of the process or software code, to define one or more policy goals. Once defined, the policy goals may be compiled and stored, and subsequently applied to evaluate the operation of the process. For example, and returning to the flight operations example, a marketing executive of an airline may create a policy goal that states that flight delays should be minimized for those flights that have heavy use passengers. In this example, the marketing executive may simply select from a predefined listing of symbolic and/or functional relationships to define the policy goal. The policy goal may then be stored in a policy database for later use by a dispatcher or the like.

The policy goals are preferably defined using, for example, entities and/or attributes defined in a structured solutions domain of the flight operations system or other process. Once defined, the policy goal may be applied to the structured model. Such a system may improve consistency of process decisions, improve the “goodness” of time-critical decisions, increase the ability to quickly recover from schedule or other process disruptions, etc.

It is contemplated that the present invention may use the policy goals to evaluate the “goodness” of a proposed dispatcher decision. Alternatively, or in addition, the present invention may use the policy goals, sometimes in conjunction with a historical database, to propose optimum decisions. Alternatively, or in addition, it is contemplated that the present invention may use the policy goals to evaluate past decisions.

The foregoing and other advantages of the present invention will become apparent from the following detailed description in which an embodiment of the invention is described in detail and illustrated in the accompanying drawings. It is contemplated that variations and structural features and arrangement of parts may appear to the person skilled in the art, without departing from the scope or sacrificing any of the advantages of the invention which is delineated in the included claims.

### BRIEF DESCRIPTION OF THE DRAWINGS

FIG. 1 is a schematic diagram showing an illustrative embodiment of the present invention;

FIG. 2 is a schematic diagram of an illustrative embodiment for analyzing historical data in support of decisions proposed by an operator and/or decisions that are automatically generating based on current conditions in view of specified policy goals;

FIG. 3 is an illustrative structured model for a flight operations system; and

FIG. 4 shows an illustrative display screen for use by the operator to create and/or modify policy goals.

### DETAILED DESCRIPTION OF THE INVENTION

The following detailed description should be read with reference to the drawings, in which like elements in different drawings are numbered in like fashion. The drawings depict selected embodiments and are not intended to limit the scope of the invention. Those skilled in the art will recognize that many of the examples provided may have suitable alternatives that could be utilized without departing from the spirit of the present invention.

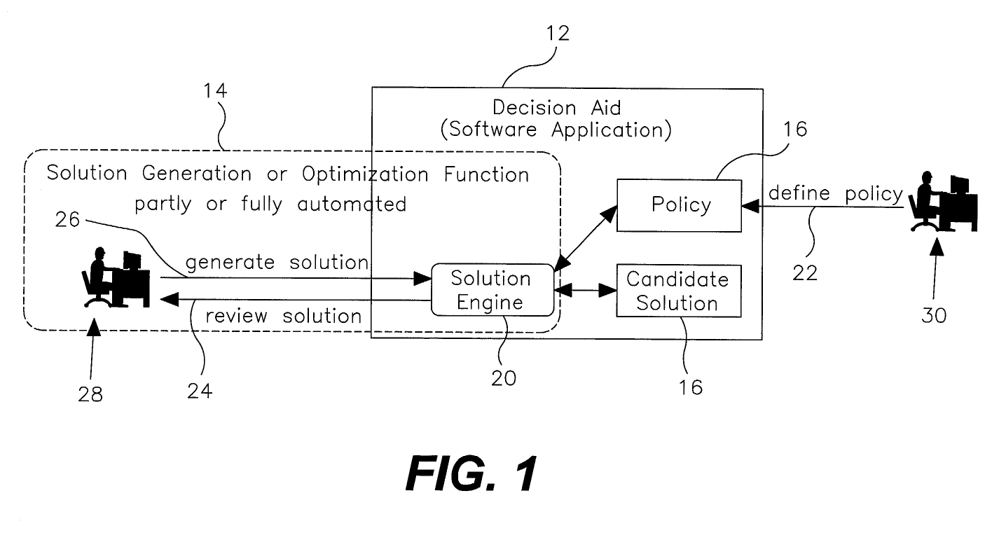

FIG. 1 is a schematic diagram showing an illustrative embodiment of the present invention. The illustrative embodiment includes a policy manager 30 for specifying policy goals along path 22 to a decision aid software application 12. Decision aid software application 12 includes a policy goals retention block 16, a library of candidate solutions 18, and a solution engine 20.

In one illustrative embodiment, policy goals retention block 16 accepts and stores system operational parameters such as policy goals that reference entities, functional relationships between entities, attributes of entities, penalty values for policy violation, etc., as specified by policy manager 30.

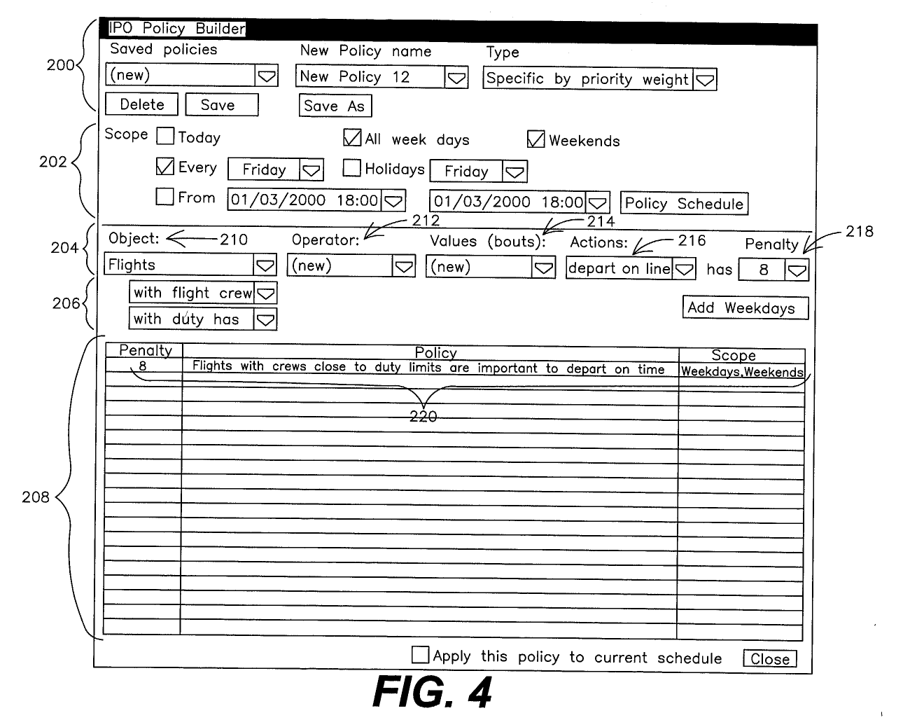

Preferably, the policy goals retention block 16 provides a user interface to the policy manager 30 that allows the policy manager 30 to specify functional relationships between entities and/or attributes of a predefined model of the process. One illustrative user interface is shown and described below with respect to FIG. 4. By providing such a user interface, personnel that do not have a detailed knowledge of the process or software code can define one or more policy goals. Once defined, the policy goals may be provided to the solution engine 20.

In one illustrative embodiment, solution engine 20 is a module of a fully or partly automated solution generation/optimization function 14. Solution engine 20 includes an interface to an operator 28, and may accept a decision proposed by operator 28 via path 26, and analyze the proposed decision in view of stored policy goals 16 to determine the impact of the operator's proposed decision on the performance of the system, and in minimizing the cumulative penalty associated with potentially violating one or more of the policy goals stored in the policy goals retention block 16. In some embodiments, only those policy goals that are violated are reported back to the operator 28, along with the penalty factor associated with the violation.

Solution engine 20 may use policy goals stored in policy goals retention block 16 and a library of candidate solutions 18 to generate one or more decisions. In some cases, the one or more decisions may be generated and provided to the operator 28 for the operator's acceptance or rejection. The decision aid block 12 may be a software application that executes on one or more computer systems, or may be implemented using specialized hardware, as desired.

Previous decisions from complex scenarios, over-ride decisions for certain operating conditions, etc., may be retained in a library of candidate solutions 18. Candidate solutions 18 may also include certain unacceptable decisions or solutions that should not be implemented irrespective of operating conditions.

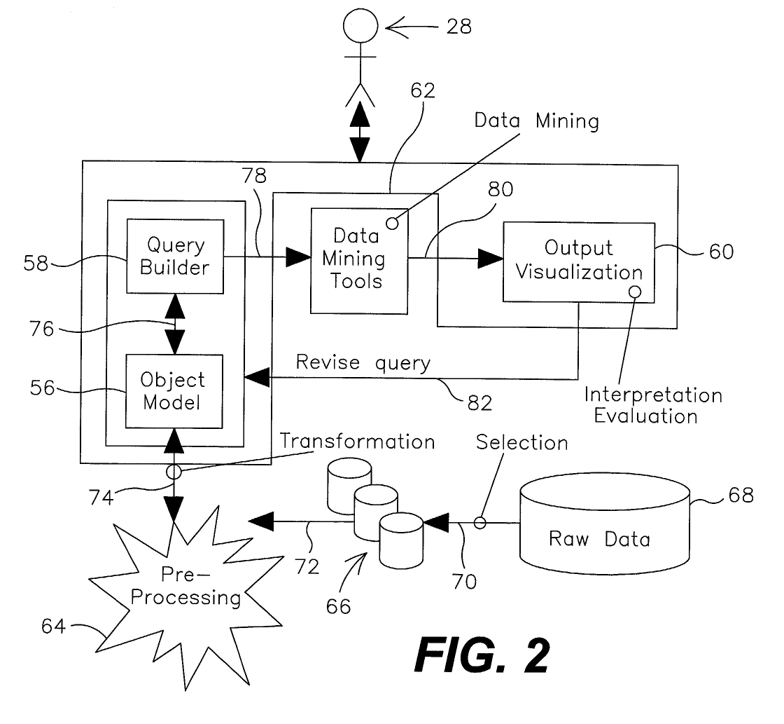

FIG. 2 is a schematic diagram of an illustrative embodiment for analyzing historical data in support of decisions proposed by an operator 28 and/or decisions that are automatically generating based on current conditions in view of specified policy goals. The analysis may discover unknown correlations in the data. In this case, policy is used to filter out the correlations that are likely coincidence rather than causal relationships. The illustrative embodiment shown in FIG. 2 relies on historical and/or current raw data 68. For airline flight operation, such historical and/or current raw data 68 may be available from the FAA and/or the airlines, from which a set of relevant data of interest 66 may be selected via path 70. Selected data of interest, shown at 66, may then be transferred along path 72 to pre-processing module 64. Pre-processing module 64 may handle missing fields, eliminate noise from the data, account for time-sequencing of events, search for patterns, identify similar prior scenarios, identify the performance of prior decisions, etc.

Data from pre-processor 64 may then be transferred along path 74 to object model 56. The object model 56 preferably is a structured model for the process or system at hand. The object model 56 may be accessed by a query builder 58 that provides a user understandable language for interacting with the object model, and to facilitate understanding, evaluation and interpretation of the resulting patterns. Preferably, query builder 58 includes an interaction vocabulary for assisting operator 28 in setting up queries and interpreting the resulting data. Operator 28 may use query builder 58 to interact along path 76 with the transformed data processed by object module 56, and to interact along path 78 with data mining tools 62.

In some embodiments, data mining tools 62 may be used to interact with decision aid software application 12 (FIG. 1), thereby taking into consideration policy goals 16, library of candidate solutions 18, and solution engine 20, as desired. This may include using policy goals 16 and query builder 58 in combination to suggest decisions and identify correlations to operator 28.

In one embodiment of the present invention, data mining tool 62 is actually a component of solution engine 20. Alternately, data mining tool 62 may interact with decision aid software application 12 and/or modules thereof such as solution engine 20 for example.

Results from data mining tools 62 may be transmitted along path 80 to output visualization module 60 for assessment by operator 28. Such post-processing and presentation of results may help assist operator 28 to more effectively interpret the results and determine their relative importance. Gaining a better understanding of the results, operator 28 may further refine object module 56 or query builder 58, as illustrated by path 82.

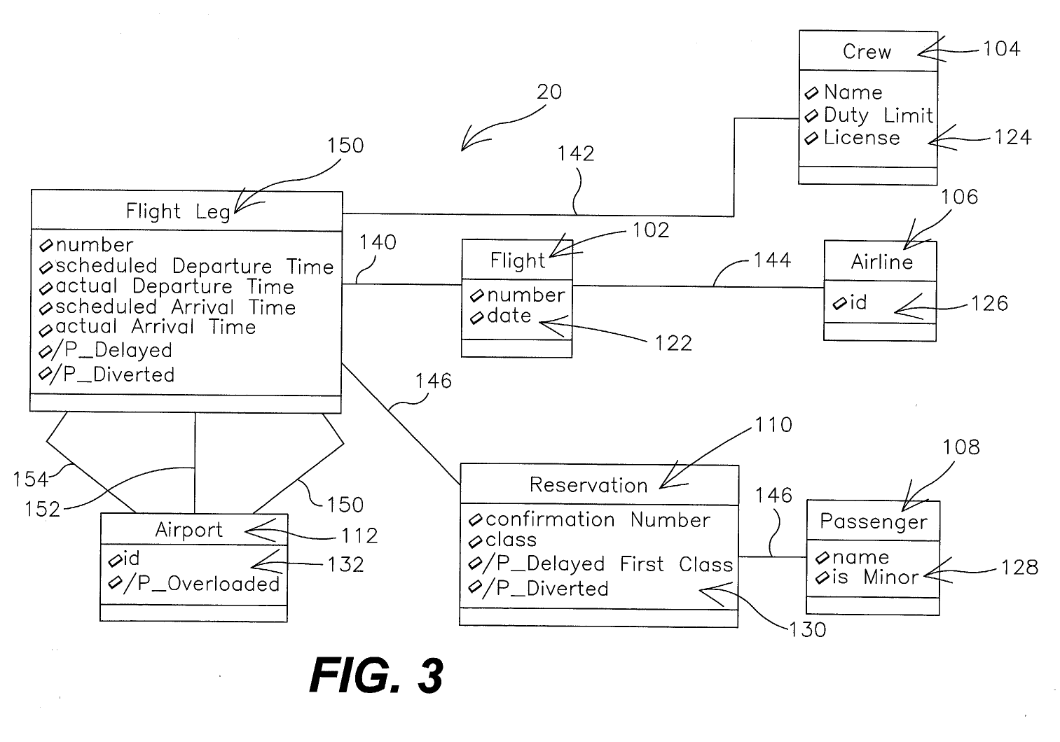

FIG. 3 is an illustrative structured model for a flight operations system. The structured model includes one or more entities, with one or more attributes for each entity, and one or more relationships between the one or more entities. In the illustrative embodiment, the structured model include a number of entities including flight leg entity 100, flight entity 102, flight crew entity 104, airline entity 106, passenger details entity 108 and itinerary entity 110, and airport entity 112. These are only illustrative entities. It is contemplated that many other entities may also be included.

Each entity includes one or more attributes for defining the characteristics of the entity. For example, the flight leg entity 100 includes attributes such as flight number, scheduled departure time, actual departure time, scheduled arrival time, actual arrival time, etc. The attributes labeled “P_” are policy goals that have been defined and saved for the entity. Typically, the attributes represent additional detailed information regarding the respective entity, such as flight number and flight date for flight entity 102 as represented by flight attribute 122, passenger name and age (e.g. unaccompanied minor vs. adult) for passenger entity 108 as represented by passenger attribute 128, etc.

Also illustrated on FIG. 3 are the relationships between the one or more entities. For example, flight leg entity 100 and flight crew entity 104 are linked by relationship 142, representing crew assignments. For example, if the aircraft arrives and/or departs late and/or is diverted to a different airport (all of which are elements of flight leg attribute 100), then one or more person from the flight crew may not be available to continue with their assignment on another flight. Similarly, passenger itinerary entity 110 is linked to both passenger detail entity 108 and flight leg entity 100 along relationships 146 and 148, respectively. It may be unwise to divert a flight having an unaccompanied minor as represented by passenger attribute 128. Under existing operating methods, a flight having an unaccompanied minor as a passenger may be diverted unknowingly, which may create an issue for the airline.

In one illustrative embodiment of the present invention, each attribute within each entity may be assigned a value representing the relative or absolute importance of that attribute compared to others. Alternatively, or in addition, each policy may be assigned a value representing the relative or absolute importance of that policy goal compared to the others. For example, penalty points on a scale from 1 to 10 (1 being the least severe and 10 being the most severe) may be assigned to each policy goal within solution model 20 such that a cumulative penalty value may be computed when one or more policy goals 16 are violated. For example, consider when an unaccompanied minor is a passenger on an airborne flight whose arrival time at the scheduled destination must be delayed or the flight must to be diverted to a different airport. Airline policy manager 30 (see FIG. 1) may have specified a penalty value of 10 (most severe) for any deviations in the schedules of flights having an unaccompanied minor. Additionally, policy manager 30 may have assigned a penalty value of 5 for delaying the arrival time at a scheduled airport, and a penalty value of 8 for diverting a flight to an alternate airport. Under this scenario, a cumulative penalty value of 15 may be computed for delaying the arrival of a flight having an unaccompanied minor, and a cumulative penalty value of 18 may be computed for diverting the aircraft to an alternate airport.

If operator 28 (see FIG. 1) attempts to divert such a flight having an unaccompanied minor, the penalty value of 18 may be displayed together with the policy and applicable attributes. The alternative of delaying the arrival time, having a cumulative penalty value of 15, may also be displayed together with the applicable attributes, and may be identified as an alternative option. Obviously, if the airborne aircraft begins to run low on fuel thus raising safety concerns, then a different set of policies and attributes need to be considered leading to a new, and potentially different, cumulative penalty value which could justify diverting the flight to an alternate airport. In the above presented scenario, the cumulative penalty value is assumed to be additive. However, any mathematical function may be used so long as there is consistency in its application.

As discussed in the foregoing description, policy manager 30 may interface with the structured model 20 for establishing policy goals 16, including attributes and associated penalty values, entities, relationships, etc. FIG. 4 shows an illustrative display screen for use by the operator to create and/or modify policy goals. The illustrative interface includes section 200 for designating the name, type, deleting, saving, etc. of a policy goals. Section 202 may be used for specifying the applicable time period for the defined policy goal. Section 204 may be used for describing the structure or function of the policy goal. Section 206 may be used for selecting qualifiers for the policy goal. Finally, section 208 may provide a list of currently defined policy goals.

Policy structure section 204 may be used by policy manager 30 to specify the function of the policy goal, including entity (a.k.a. objects) 210, operators 212, values 214, attributes (or actions) 216, and penalty value 218, each having a drop-down menu. In the illustrative embodiment shown, policy manager 30 is indicated as having specified a penalty value of 8 points at 218 for flights 210 that have flight crews within (operator 212) 2 hours (value 214) of their duty limits (qualifiers 206) that do not depart on time (actions 216). This policy goal is parsed into operator understandable form 220 and displayed on table 208 for policy manager 30. The entities, attributes, actions and operators may all be predefined, with the entities and attributes predefined in the structured model 20 for flight operations.

It is contemplated that a number of policy goals may be bundled together, and run collectively or individually. For example, one policy bundle may be used during normal season flight operations, while another policy bundle may be used during pre-holiday operations. It may be more important for the majority of passengers to reach their destination (even if late) during the holidays, while during normal operations, it may be more important for the majority of passengers to be on time (even at the cost of some passengers not reaching their destinations).

While a flight operation example is provided above, other applications are contemplated. For example, the present invention may be applied to manufacturing processes, business processes, scheduling processes, as well as many other processes. For example, the present invention may be applied to processes that are used to create and/or change the schedules of service providers that respond to service calls. In this example, entities and attributes of the structured model may include, for example, familiarity of the service provider with a customer site, the match of skills of the service provider to the problem at hand, the distance from the service provider to a customer site, etc. In one example, policy managers might specify a policy of “just get it done” on busy days, and to maximize customer satisfaction on less busy days.

In another example, the present invention may be applied to processes used for energy load shedding in a commercial and/or industrial building in response to real-time pricing changes as relayed by one or more utility companies. In another example, the present invention may be applied to processes used for traveler profiling during security screening. In this example, entities and attributes of the structured model may include, for example, the travelers country of origin, baggage characteristics, ticket type, credentials, itinerary, local/global security situation, etc.

Numerous advantages of the invention covered by this document have been set forth in the foregoing description. It will be understood, however, that this disclosure is, in many respects, only illustrative. Changes may be made in details, particularly in matters of shape, size, and arrangement of parts without exceeding the scope of the invention. The invention's scope is, of course, defined in the language in which the appended claims are expressed.

We claim:

1. A method for evaluating the operation of a system relative to one or more policy goals, the method comprising:
providing a structured model for modeling the operation of the system, the structured model having a plurality of entities, each entity having one or more attributes and one or more relationships between the entities;
allowing a user to provide one or more policy goals, the one or more policy goals referencing, at least in part, one or more of the entities and/or attributes of the structured solution space; and
applying the one or more policy goals against the structured model to determine how well the system performed relative to the one or more policy goals.

2. A method according to claim 1 wherein the one or more policy goals have weights that indicate the relative importance of the policy goal.

3. A method according to claim 3 further comprising the step of aggregating the weights of the one or more policy goals to provide an aggregate policy goal metric.

4. A method according to claim 1 wherein selected policy goals define a functional expression referencing one or more of the entities, attributes, and/or relationships of the structured model.

5. A method according to claim 4 wherein the functional expression includes Boolean operators.

6. A method according to claim 4 wherein selected policy goals further include one or more functional parameters.

7. A method according to claim 6 wherein one or more of the functional parameters include weights.

8. A method according to claim 6 wherein one or more of the functional parameters include limits.

9. A method according to claim 1 wherein the selected policy goals are specified by a user via a user interface that provides a reference to one or more of the entities, attributes, and/or relationships of the structured model.

10. A method according to claim 9 wherein the user interface allows the user to define one or more policy goals referencing selected entities and/or attributes of the structured model.

11. A method according to claim 1 further comprising the steps of:
allowing a user to propose a change to the operation of the system;
applying the one or more policy goals to the structured model with the proposed change to determine how well the system performed relative to the one or more policy goals.

12. A method according to claim 11 wherein the one or more policy goals have weights that indicate the relative importance of the policy goal.

13. A method according to claim 12 further comprising the step of aggregating the weights of the one or more policy goals to provide an aggregate policy goal metric.

14. A method according to claim 1 further comprising the step of searching a historical database of past system performance to identify a historical change to the operation of the system that is similar to the proposed change.

15. A method according to claim 14 further comprising the step of applying the one or more policy goals to the structured model with the historical change to determine how well the system performed relative to the one or more policy goals.

16. A method according to claim 15 further comprising the step of identifying a historical change that causes the system to perform relatively well relative to the one or more policy goals.

17. A method for evaluating the operation of a process under a proposed change, the method comprising:
providing one or more policy goals;
proposing a change to the operation of the process;
applying the one or more policy goals to determine how well the process performs with the proposed change relative to the one or more policy goals; and
reporting how well the process performs with the proposed change relative to the one or more policy goals.

18. A method according to claim 17 wherein the reporting step reports which of the one or more policy goals was violated, if any.

19. A method for evaluating the operation of a process under a proposed change, the method comprising:
allowing a policy manager to provide one or more policy goals;
storing the one or more policy goals;
providing a structured solutions domain for the process;
proposing a change to the operation of the process;
applying the one or more policy goals to the structured solutions domain to determine how well the process performs with the proposed change relative to the one or more policy goals; and
reporting how well the process performs with the proposed change relative to the one or more policy goals.

20. A method according to claim 19 wherein the reporting step reports which of the one or more policy goals was violated, if any.
